(19) United States
(12) Patent Application Publication
(10) Pub. No.: US 2004/0042797 A1
(43) Pub. Date: Mar. 4, 2004

(54) Low profile FSO transceiver and apparatus for mounting same to a window

(76) Inventors: Nicholas Bratt, Edmonds, WA (US); Chace Fadlovich, Bothell, WA (US); Robert M. Pierce, Woodinville, WA (US); Rick Riday, Kirkland, WA (US); Jorah Wyer, Towson, MD (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/232,120

(22) Filed: Aug. 30, 2002

(51) Int. Cl. H04B 10/00; H04B 10/10

(52) U.S. Cl. 398/128; 398/129

(57) ABSTRACT

A free-space optical (FSO) transceiver head and mounting assembly to enable the FSO transceiver head to be mounted to a window. The FSO transceiver head has a binocular configuration including respective sets of transmit and receive optics configured to facilitate transmission and reception of optical signals. The mounting assembly provides a pair of adjustable axes to enable the FSO transceiver head to be rotated and tilted relative to an axis that is normal to the window. The mounting assembly also provides adjustable feet for fine-pointing. Upon assembly, the entire apparatus has a depth of approximately 3½ inches, enabling it to be deployed in a standard-sized window frame behind a window blind. The apparatus may also be deployed in vehicle windows and out-building windows. A breakaway feature is also provided such that the apparatus will break free from a window rather than having the window break when a sufficient force is applied to the mounting assembly and/or transceiver head.

### BACKGROUND OF THE INVENTION

1. Field of the Invention

The present invention generally relates to free-space optical (FSO) communications systems, and, more specifically, to a low-profile FSO transceiver and an apparatus for mounting the transceiver to a window.

2. Background Information

With the increasing popularity of wide area networks (WANs), such as the Internet and/or the World Wide Web, network growth and traffic has exploded in recent years. Network users continue to demand faster networks and more access for both businesses and consumers. As network demands continue to increase, existing network infrastructures and technologies are reaching their limits.

An alternative to present day hardwired or fiber network solutions is the use of wireless optical communications. Wireless optical communications utilize point-to-point communications through free-space and therefore do not require the routing of cables or fibers between locations. Thus, wireless optical communications are also known as free-space or atmospheric optical communications. For instance, in a free-space optical communication system, a beam of light is directed through free-space from a transmitter at a first location to a receiver at a second location. Data or information is encoded into the beam of light, and therefore, the information is transmitted through free-space from the first location to the second location.

A conventional free-space optical system is shown in FIGS. 1A and 1B. The free-space optical system includes a pair of terminals (i.e., transceivers) 10 that are typically located on or in separate buildings or towers, such as depicted by buildings 11 and 12. Each terminal 10 includes a primary collector 13 to which a secondary mirror 14 is coupled via a plurality of rigid struts 16. The terminals further include a transmitted signal lens 18 mounted within secondary mirror 14, and a set of transmitter/receiver optics and electronics 20. All of components 13, 14, 16, 18, and 20 are operatively coupled to a yoke that is connected to a base 22 via a gimbal assembly, such that these components are all moved in response to a gimbaled movement of the yoke relative to a static surface on which the base 22 is placed.

With reference to FIG. 1B, data is transmitted from a terminal 10T to a terminal 10R in the following manner. An optical signal 24 is generated by transmitter/receiver optics and electronics 20T of terminal 10T and directed through an opening 26T defined in primary collector 13T towards transmitted signal lens 18T, which produces a collimated signal 28. As collimated signal 28 moves toward terminal 10R, the width of the signal diverges very gradually. As will be recognized by those skilled in the art, the divergence of the various optical signals depicted in the Figures contained herein are exaggerated for clarity. Upon reaching terminal 10R, the outer portions of collimated signal 28 impinge upon primary collector 13R, which comprises a concave mirrored surface that redirects those portions of the signal that impinge upon it toward secondary mirror 14R. Collimated signal 28 is then reflected by secondary mirror 14R towards the secondary mirror's focal point 30, where it is received by transmitter/receiver optics and electronics 20R.

The conventional terminal mounting technique that employs the base and gimbaled assembly discussed above has several drawbacks. One drawback is that since the base is typically mounted on a floor, the terminal is susceptible to floor motion, such as vibrations caused by people and/or equipment in offices or rooms in which the terminal is located. The conventional terminal is also somewhat obtrusive, occupying a significant amount of office space. Furthermore, the conventional mounting technique enables users to potentially cause damage to a terminal and interfere with received or transmitted signals. Accordingly, it would be advantageous to provide FSO transceivers and mounting equipment that enables FSO equipment to be deployed in an office such that the equipment has minimal impact on the office environment, and the activity of office personnel are unlikely to cause adverse effects to the FSO equipment.

### SUMMARY OF THE INVENTION

A free-space optical (FSO) transceiver head and mounting assembly to enable the FSO transceiver head to be mounted to a window. The FSO transceiver head has a binocular configuration including respective sets of transmit and receive optics configured to facilitate transmission and reception of optical signals. The mounting assembly provides a pair of adjustable axes to enable the FSO transceiver head to be rotated and tilted relative to an axis that is normal to the window. The mounting assembly also provides adjustable feet for fine-pointing. Upon assembly, the entire apparatus has a depth of approximately 3½ inches, enabling it to be deployed in a standard-sized window frame behind a window blind. Generally, the apparatus may be deployed on any type of window, including but not limited to office windows, vehicle windows and outbuilding windows. A breakaway feature is also provided such that the apparatus will break free from a window to which it is mounted rather than having the window break when a sufficient force is applied to the mounting assembly and/or transceiver head.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is an illustration of a conventional free-space optical communications system that uses on-axis primary and secondary reflectors and provides transmitting and receiving capabilities at a pair of transceiver stations disposed at remote locations within respective buildings;

FIG. 1B shows how an optical communications signal is transmitted by a first transceiver station and received by a second transceiver station;

FIG. 2 is an exploded view of an FSO transceiver head and mounting assembly in accordance with one embodiment of the invention;

FIG. 3 is an assembled view of the apparatus of FIG. 2;

FIG. 4 is an isometric view of the apparatus of FIG. 2 viewed from outside of a window to which the apparatus is mounted, wherein the front plate has been removed for to more clearly illustrate the components disposed behind it;

FIG. 5 is an isometric view of the apparatus of FIG. 3, wherein the transceiver head is rotated 45 degrees about a pivotal X axis.

FIG. 6 is a partially-exploded view of the apparatus of FIG. 3 showing further details of the adjustable feet employed by the invention to enable fine pointing of the transceiver head;

FIG. 7 is an exploded view illustrating further details of the FSO transceiver head of FIG. 2;

FIG. 8 is a frontal elevation view of the FSO transceiver head;

FIG. 9 is an exploded view of a fiber positioner assembly used to position the end of optical fibers used for receiving and transmitting optical signals;

FIG. 10 is an isometric view of a positioning fixture used to align the fiber positioner assemblies within the primary optics of the transceiver heads;

FIG. 11 is a cross-section view corresponding to section cut 11-11 of FIG. 3;

FIG. 12 is an isometric view of the apparatus of FIG. 2 further including a cover used to protect the apparatus from access by unauthorized personnel;

FIGS. 13A, 13B, and 13C show various views of one embodiment of a detachable foot mount assembly, wherein FIG. 13A shows an exploded isometric view, FIG. 13B shows a plan view, and FIG. 13C shows an elevation sectional view corresponding to the section cut 13C-13C or FIG. 13B; and

FIG. 14A shows an isometric view of an apparatus installation employing a window-frame mounting assembly that is mounted to a window frame.

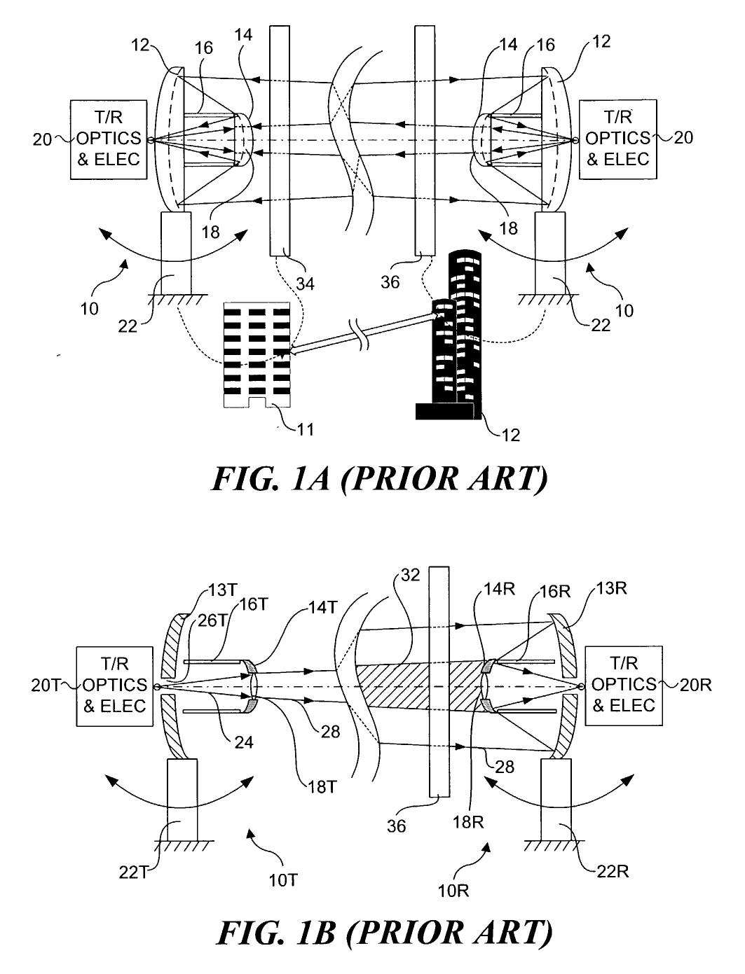

### DETAILED DESCRIPTION

Embodiments of a free-space optical (FSO) transceiver head and mounting assembly to enable the FSO transceiver head to be mounted to a window are described herein. In the following description, numerous specific details are disclosed to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In one example embodiment of the present invention, point-to-point free-space optical communications are provided from a transmitter to a receiver. The transmitter and receiver may be located at the same location or at different locations such as on different buildings within a line of sight of each other. It is appreciated that the transmitter and the receiver may be parts of transceivers, or transmitter-receiver combinations, at their respective locations, such that bi-directional communications are provided. In the example embodiment, the transmitter includes an optical source that generates an optical communications beam, such as a laser beam or the like, on which data or information is modulated. The optical communications beam is not limited to being monochromatic or to any particular wavelength or color and may include the visible light as well as ultra violet or infra-red portions of the spectrum.

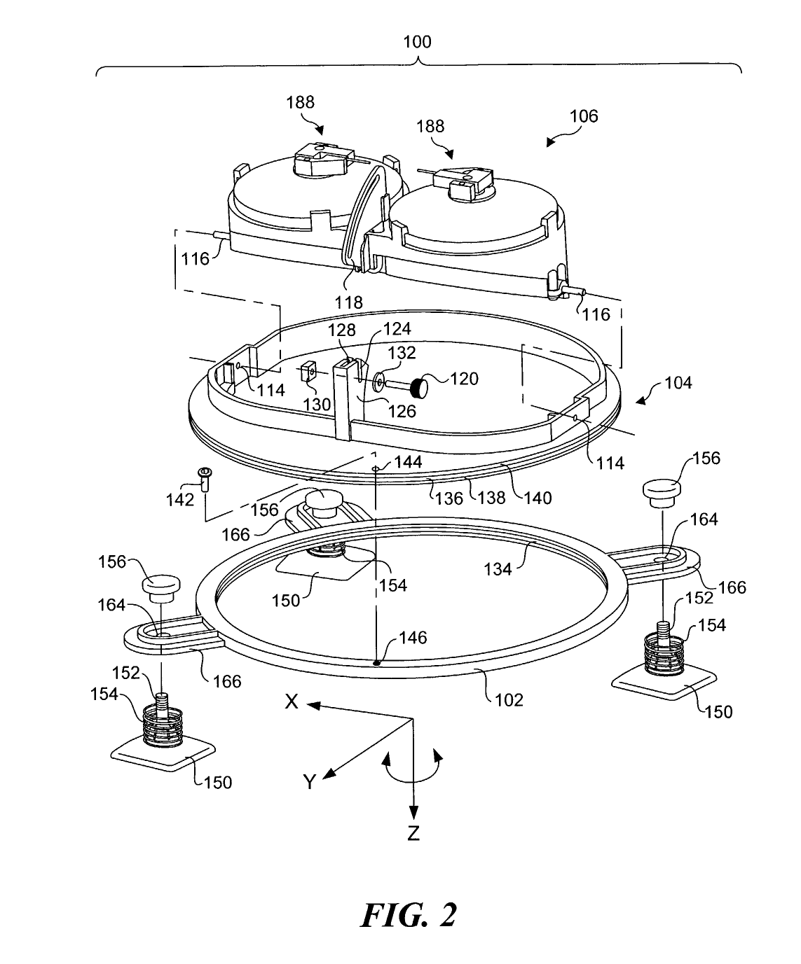

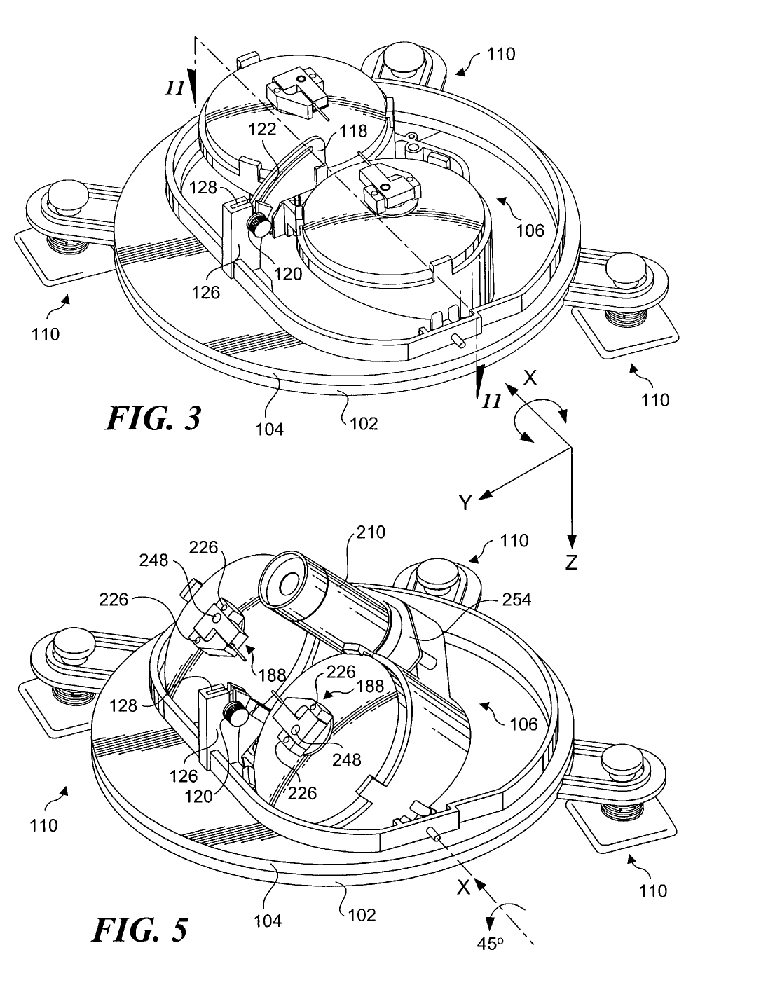

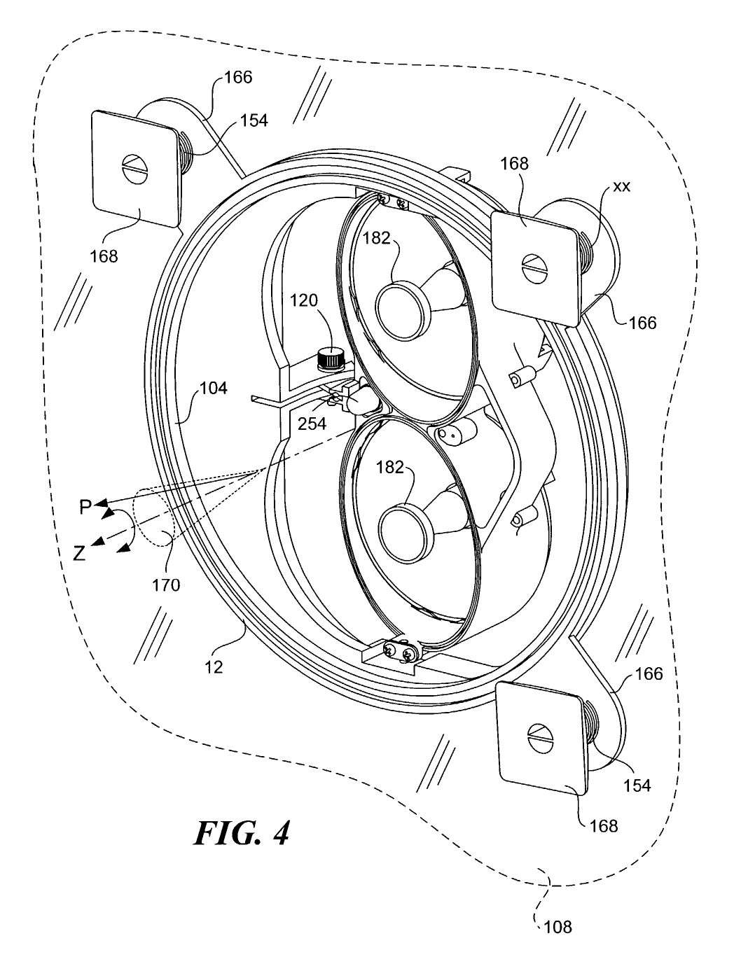

Exploded and assembled isometric views of an apparatus 100 comprising a low-profile binocular FSO transceiver and associated window mounting assembly in accordance with one embodiment of the invention are respectively shown in FIGS. 2 and 3. Primary components and subassemblies of apparatus 100 include a base plate 102, a coarse pointing ring 104, and an FSO transceiver head 106. As further shown in FIG. 4, upon deployment, base plate 102 is mounted to a window 108 via a plurality of adjustable feet 110. Coarse pointing ring 104 is rotatably-coupled to base plate 102 via a “slip ring” interface, thereby enabling the coarse pointing ring and transceiver head 106 to be rotated about a Z axis that is normal to the window to form a first axis of rotation.

Transceiver head 106 is pivotally mounted to coarse pointing ring 104 via a pair of trunnion mounts, each including a plain bearing 114 and a shaft 116, thereby enabling transceiver head 106 to be pivoted about an X axis to form a second axis of rotation. In one embodiment, the configuration of the mounting assembly and transceiver head 106 is such that the transceiver has a field of regard of plus or minus 45 degrees. For example, in the embodiment, transceiver head 106 may be rotated approximately plus 45 degrees about the X axis; as shown in FIG. 5; to get the minus 45 degrees, the coarse pointing ring is rotated 180 degrees about the Z axis. The position of the transceiver head about the X-axis is secured via a clamping mechanism that includes a coarse pointing fin 118 and a locking screw 120. Upon assembly, the shaft of locking screw 120 is disposed within both a slot 122 defined in the coarse mounting fin and a slot 124 defined in an upright member 126 extending upward from coarse pointing ring 104. The upright member further includes a slot 128 that is configured to slidingly engage the sides of coarse pointing fin 118. Once a desired position of transceiver head 106 about the X-axis is reached, locking screw 120 is tightened (through threading into a nut 130), thereby locking the position in place. If desired, an optional washer 132 may also be employed.

In one embodiment, the “slip ring” interface between base plate 102 and coarse mounting ring 104 is configured in the following manner. A groove 134 is formed in the internal periphery of base plate 102. In general, a tongue will be formed around an external periphery of coarse pointing ring 104 to mate with the groove formed in base plate 102, thereby forming a tongue and groove interface. In the illustrated embodiment, a groove 136 is formed in the periphery of coarse pointing ring 104 so as to define a pair of flanges 138 and 140, wherein flange 138 functions as the tongue. In the illustrated embodiment, the rotation position of the coarse pointing ring about the Z-axis is secured via one or more screws 142 that are threaded into respective threaded holes 144, causing the end of the screws to engage an opposing portion 146 on the top of the base plate.

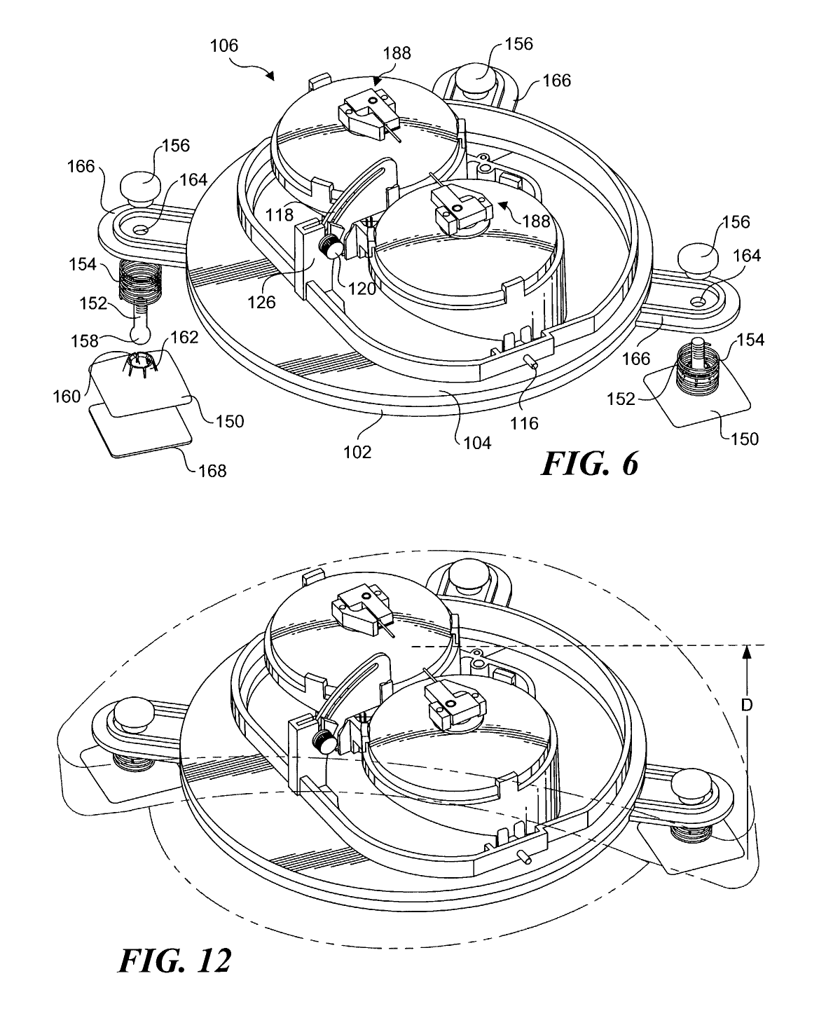

With further reference to FIG. 6, in one embodiment each of adjustable feet 110 comprise a base 150, a threaded shaft 152, a helical spring 154, and an internally threaded cap 156. Upon assembly, a ball-end 158 of threaded shaft 152 is captured by a socket 160 defined within a slotted boss 162 formed in the base. The threaded end of thread shaft 152 passes through a hole 164 defined in a lobe 166 extended outward from base plate 102, and the lobe is captured by threading internally-threaded cap 156 onto threaded shaft 152. In one embodiment, base 150 is secured to the window using a double-sided adhesive 168. Optionally, other common means may be used to secure bases 150 to the window.

Typically, three adjustable feet 110 will be employed, enabling the base plate to be pivoted in a tripod-like manner. In this instance, the adjustable feet may be disposed approximately 120 degrees apart, as is common for a typical tripod, or may be disposed with uneven angular separations, such as depicted in the Figures herein. The adjustable feet enable the distance between each lobe 166 and window 108 to be independently adjusted by turning threaded caps 156 so as to increase or decrease the height of helical springs 154. Generally, these “fine pointing” adjustments will be made after coarse positioning adjustments (i.e., coarse rotational positioning about the Z and X axes) have been performed. As a result, a pointing direction P of the transceiver head can be finely positioned along any direction within a “cone of pivotation” 170.

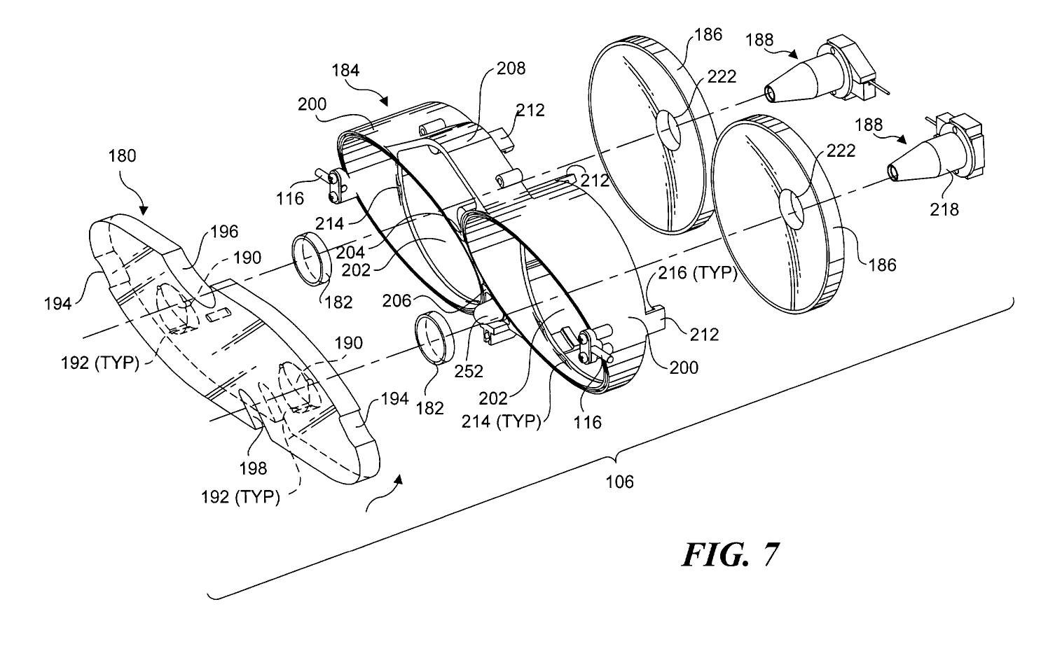

With reference to FIG. 7, in one embodiment transceiver head 106 includes an optically-transparent front plate 180, a pair of secondary optics 182, a chassis 184, a pair of primary optics 186, and a pair of fiber positioner assemblies 188. As defined herein, optically-transparent means that the component is made of a material through which an FSO optical signal may pass with minimal attenuation. It is noted that since FSO optical signals may comprise infra-red light, which is not visible to the human eye, an optically-transparent component does not need to appear transparent to the human eye. In one embodiment, front plate 180 is made of a clear acrylic (which is visibly clear).

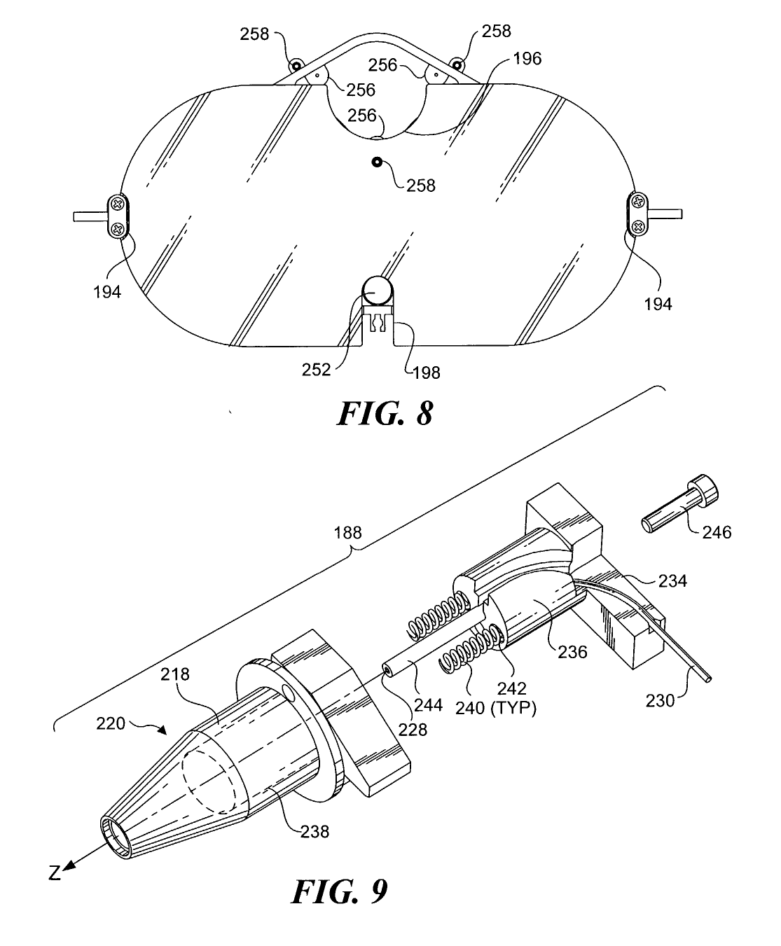

Upon assembly, secondary optics 182 are disposed within respective recesses 190 defined in the backside of front plate 180. Each secondary optic may be secured within its corresponding recess using one of many conventional mounting techniques, such as adhesives, fasteners, and the like. In one embodiment, a plurality of slots 192 are defined on the periphery of recesses 190 to hold liquid adhesive, whereby the secondary optic is secured when the adhesive cures. Likewise, front plate 180 may be secured to chassis 54 using a conventional mounting technique. In one embodiment, an adhesive is used to bond the front plate to the chassis. Front plate 50 also includes a pair of horizontally-disposed cutouts 194 and vertically-disposed cutouts 196 and 198 to assist in securing the front plate to chassis 184, further details of which are in shown FIG. 8.

In the illustrated embodiment, chassis 184 comprises a pair of wedge-cut tubes 200 that define respective chambers 202. The wedge-cut tubes are connected by an upper web 204 and a lower web 206. In one embodiment, a bridge 208 is also connected between the tubes. As explained in further detail below, bridge 208 is used to facilitate mounting of an alignment scope 210 to the transceiver head.

Upon assembly, primary optics 186 are secured within respective chambers 202. In one embodiment, this is enabled by means of a plurality of tabs 212 extending toward the back of each wedge-cut tubes 200 and a plurality of ledges 214 defined within respective chambers 202, whereby the primary optics are encapsulated between a frontside 216 of the tabs and a backside of the ledges.

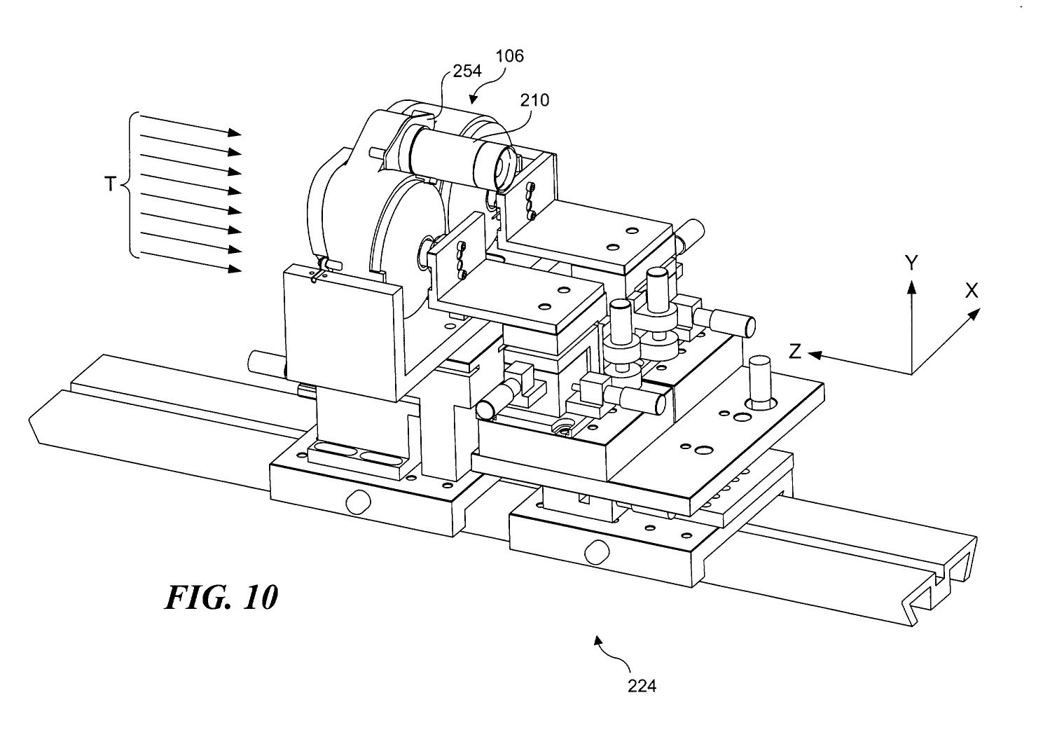

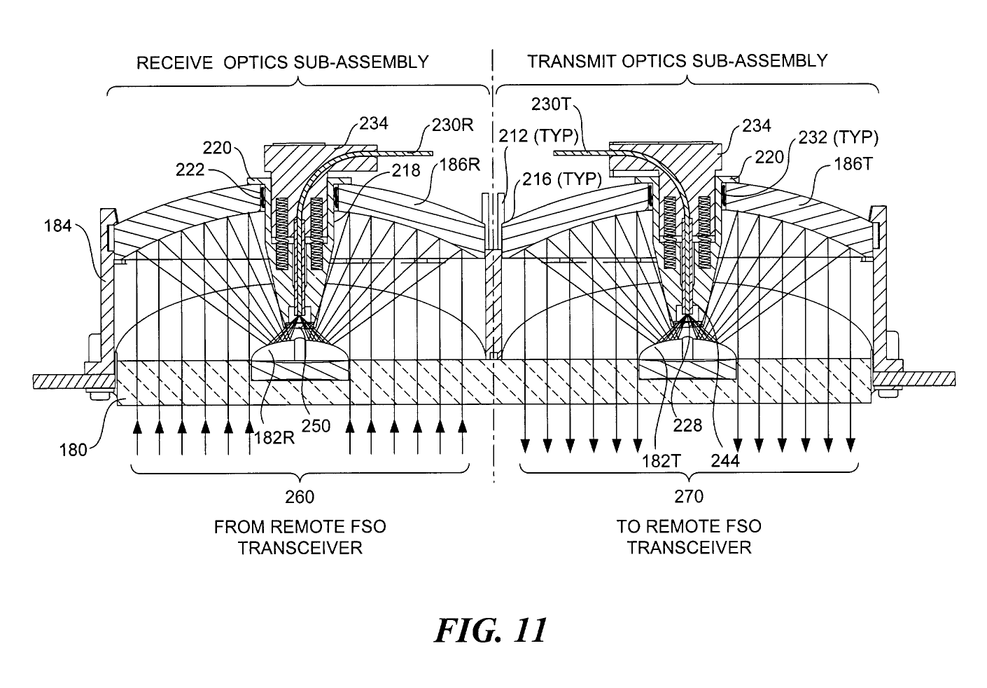

Once the front plate, secondary optics chassis and primary optics are assembled, fiber positioner assemblies 188 are secured to the backside of the primary optics. Upon assembly, a cylindrical portion 218 of a fiber positioner body 220 (see FIG. 9) is disposed with an aperture 222 defined through the center of each primary optic. The diameter of aperture 222 is slightly larger than the diameter of cylindrical portion 218, thereby enabling the fiber positioner assembles to be positioned along the X and Y axis. In one embodiment, a positioning fixture 224 is used to position the fiber positioner assembles within the respective holes during an alignment process in which a test signal T is directed toward the transceiver head, as shown in FIG. 10. During the positioning process, a pair of alignment pins engage a pair of respective alignment holes 226 defined in each fiber positioner assembly. The position of each fiber positioner assembly is adjusted in the X and Y directions, as appropriate, via X and Y stages of the positioning fixture until a desired XY alignment of an end 228 of an optical fiber 230 is obtained, further details of which are shown in FIG. 11. An adhesive 232 is then injected into the gap between cylindrical portion 218 and aperture 222 and allowed to cure to secure each fiber positioner assembly to its respective primary optic (optionally, the adhesive may be applied to cylindrical portion 218 prior to inserting the positioner body into aperture 222).

As further shown in FIG. 9, each fiber positioner assembly 188 includes a Z-axis fiber positioner block 234 having a cylindrical extension 236 that slidingly engages the surface of a bore 238 defined in fiber positioner body 220 to enable the end 228 of optical fiber 230 to be positioned along the Z axis. Positioning along the Z axis is further enabled by a pair of springs 240 having first ends that are captured within respective holes 242 defined in Z-axis fiber positioner block 234 and opposing ends that are defined within corresponding holes (not shown) defined in fiber positioner body 220. Z-axis fiber positioner block 234 further includes a hole from which a fiber alignment tube 244 extends, wherein the fiber alignment tube is used to fixedly position the end 228 of optical fiber 230 relative to the positioner block. Upon assembly, a shoulder screw 246 having a threaded shaft that engages a threaded hole defined in fiber positioner body 220 (not shown) is used to adjust the Z-axis position of the end of the optical fiber. The shaft and head of the shoulder screw are disposed within a counterbore 248 defined in Z-axis fiber positioner block 234 (See, e.g., FIG. 5). An optional dust cover 250 may be provided to prevent dust and other particulars from obscuring the end of the optical fiber.

A pair of apparatus' 10 are installed in respective offices to provide a FSO link between network nodes to which the transceivers are attached. In order to establish the FSO link, the two transceivers first must be aligned. The alignment process is facilitated by the pivotal transceiver head positioning adjustments about the X and Z axes, and the tripod-like positional adjustment that is provided by adjustable feet 110. Initially, coarse adjustments will be made to align the transceivers. This is further facilitated by alignment scope 210 and a beacon 252.

During the foregoing fiber positioner assembly alignment process, alignment scope 210 is also aligned with the optics of transceiver head 106. In one embodiment, alignment scope 210 is coupled to a mounting plate 254 made of a magnetic material, such as steel, as shown in FIG. 5. In one configuration, three magnets (not shown) are mounted to the backside of three mounting pads 256 radially-spaced 120 degrees apart, as shown in FIG. 8. Upon assembly, mounting plate 254 is drawn toward these magnets. At the same time, three screws (not shown) are threaded into threaded holes 258 defined in chassis 184 so as to engage the underside of mounting plate 254, enabling the alignment scope to be positioned in a tripod-like manner.

The use of the foregoing magnetic attachment scheme enables the alignment scope to be easily removed after the FSO transceiver heads have been properly aligned. Furthermore, the scheme enables the alignment scope to be reattached for further alignment, if necessary, whereby the alignment scope will still be properly aligned with the FSO optics.

Returning to FIG. 11, a plurality of ray traces corresponding to a received optical signal 260 and a transmitted optical signal 270 are shown. As depicted, the transceiver head includes a receive sub-assembly comprising the left half of the cross-section, and a transmit sub-assembly comprising the right half of the cross-section. In the illustrated embodiment, components that make up receive and transmit sub-assemblies are substantially identical. Optionally, the components of the two sub-assemblies may have different configurations.

The receive optical signal 260, which is transmitted by another FSO transceiver disposed in a remote location (e.g., in another building), is collected by a primary receive optic 186R. The primary receive optic comprises a parabolic mirror that is configured to redirect the light rays toward a secondary receive optic 182R. The light rays are then reflected toward the end of a receive optical fiber 230R, which receives the incoming receive optic signal. The receive optic signal passes through the receive optical fiber and is processed using circuitry designed for such purposes. In one embodiment, a portion of the circuitry may be located proximate to the transceiver head, e.g., within an enclosure covering the apparatus, is shown in FIG. 12. In another embodiment, the circuitry is located in a remote chassis that is linked to the transceiver head using appropriate fiber-based cabling.

The light paths illustrated by the ray traces for the transmitted optical signal 270 are substantially identical to the received optical signal, except in the reverse direction. Accordingly, the transmitted optical signal begins as a modulated optical beam that is emitted out of the end 228 of a transmit optical fiber 230T. As the modulated optical beam exits the optical fiber, it impinges on various portions of a secondary transmit optic 182T. The light rays are then directed toward a primary transmit optic 186T, which redirects the light rays outward to be received by a remote FSO transceiver. As with the receive subassembly, the transmit subassembly may further include circuitry for generating the modulated optical beam that may be disposed proximate to the transceiver head, or in a remote chassis connected to the transceiver head using appropriate fiber-based cabling.

As further depicted in FIG. 12, the apparatus may be configured such that it occupies an envelope of space having a depth D of approximately 3½ inches. Accordingly, the apparatus may be installed within a standard window frame. In fact, depending on the particular installation, the apparatus may be installed on a window behind a window blind, whereby the occupants of the office in which the apparatus is installed may not even be aware of its presence.

Breakaway Feature

In accordance with one aspect of the invention, the mounting assembly is configured to break away from it mounting surface (e.g., a window) when a sufficient force (e.g., a moment, horizontal, or vertical force) is applied to the mounting assembly and/or the FSO transceiver head. This breakaway feature provides enhanced safety in the event the apparatus is grabbed or otherwise disturbed by someone proximate to the window. For example, in one embodiment described below, the apparatus will become detached from its feet rather than possibly causing the window to break.

Returning to FIG. 6, upon assembly, ball-end 158 of threaded shaft 152 is captured by socket 160 defined in slotted boss 162, as discussed above. The slots in the boss enable the socket to expand to receive the ball-end of the shaft when a sufficient force is applied to the threaded shaft toward the socket. This mechanism works similarly in reverse. Upon sufficient force being applied to the threaded shaft away from the socket, the top portion of the ball end engages the inner lip of the socket, causing the socket to expand, thereby enabling the shaft to be detached. Since the base 150 of each of the adjustable feet is affixed to the window via double-sided adhesive 168, and threaded shafts 152 are operatively coupled to coarse pointing ring 102 (and thus the mounting assembly), the remainder of the apparatus (i.e., mounting assembly and FSO transceiver head) will become detached from the window when sufficient force is applied to either the transceiver head or the mounting assembly, thus preventing the window from being broken.

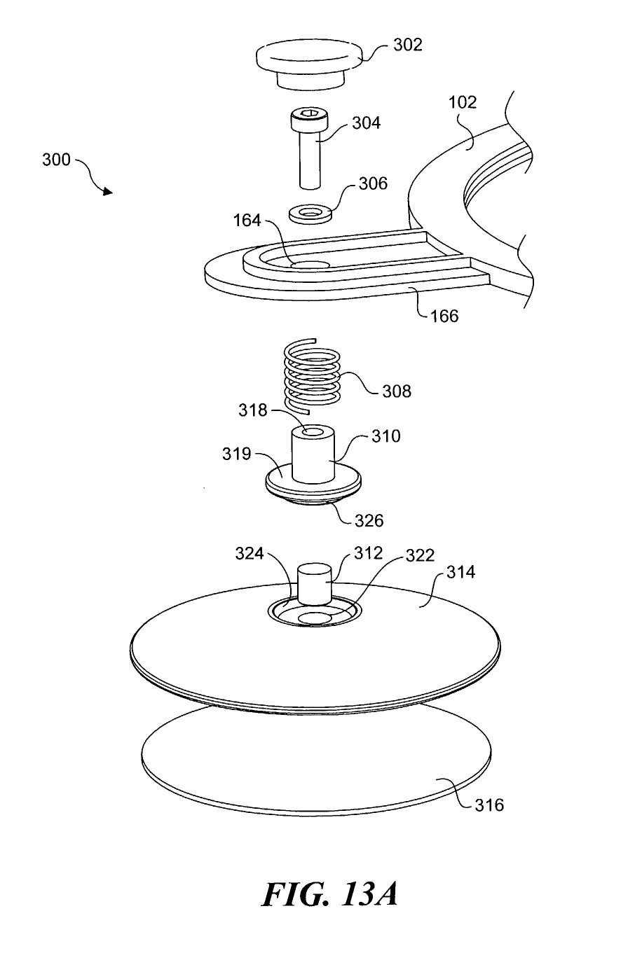

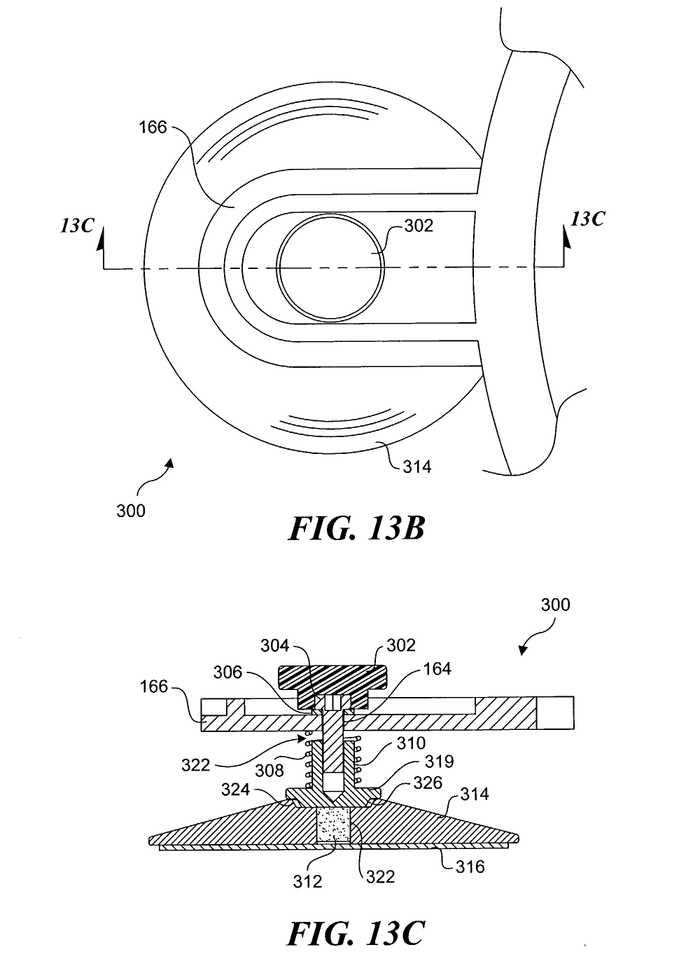

Various views corresponding to a second embodiment of a detachable foot assembly 300 is shown in FIGS. 13A-13C. Assembly 300 includes a cap 302, a fine pointing adjustment screw 304, a washer 306, a helical compression spring 308, a steel leg 310, a magnet 312, a foot 314, and an adhesive pad 316. Generally, the head of fine pointing adjustment screw 304 will be secured within a recess in cap 302, such as via a press fit or adhesive. Optionally, the combination of the cap and screw may be purchased as a single component.

Upon assembly, the upper portion of the shaft of fine pointing adjustment screw 304 is disposed within hole 164 of lobe 166, as depicted in FIG. 13C. The lower threaded portion of shaft is threaded into mating threads formed in a bore 318 of steel leg 310. The helical compression spring 308 is captured around the minor diameter potion of steel leg 310, and is compressed via opposing surfaces comprising the underside of lobe 166 and a shoulder 319 formed in steel leg 310, whereby a gap 320 between the base of lobe 166 and the top of steel leg 310 may be adjusted by turning the fine pointing adjustment screw via cap 302.

Magnet 312 is disposed within a bore 322 passing though foot 314 and secured within the bore via a press fit or adhesive. In one embodiment, foot 314 is made of aluminum. Foot 314 may be made of other common materials as wells, such as plastics and various metals. Preferable, foot 314 will be made of a nonferromagnetic material, but this isn't a strict requirement. The head of magnet 312 is positioned such that the base of steel leg 310 is coupled to it via magnetic attraction. Furthermore, the base of the steel leg is disposed with a chamfered recess 324 formed in foot 314 and includes a mating chamfer 326 (having a large diameter). The chamfered edges improve side load release and ease assembly.

Upon assembly of an apparatus (e.g., apparatus 100) employing detachable foot assembly 300, feet 314 are secured to a window via adhesive pads 316. In one embodiment, detachable foot assembly 300 will be pre-assembled prior to securing the apparatus to the window so as to properly position feet 314. In an optional embodiment, a template may be used to position the feet on the window.

In the event of an undesirable load is applied to FSO transceiver head 106 and/or the mounting apparatus, steel legs 310, the magnetic force securing the base of steel legs 310 to feet 314 will be exceeded, causing the mounting apparatus and FSO transceiver head to be detached from the window. The amount of force necessary to produce this result may be tuned via magnet sizing, coupling surface dimensions, and magnetic strength. Thus, damage to the window can be prevented, enhancing safety. Reattachment of the mounting apparatus may be performed by simply reseating the steel legs 310 within chamfered recesses 324.

In the illustrated embodiments described above, the apparatus is generally mounted to a window, such as an office window. This is not meant to be limiting, as the apparatus may be mounted to any type of window, including vehicle windows (e.g., automobiles, boats, aircraft, etc.) and windows for outside installations, such as outdoor cabinets and out-buildings.

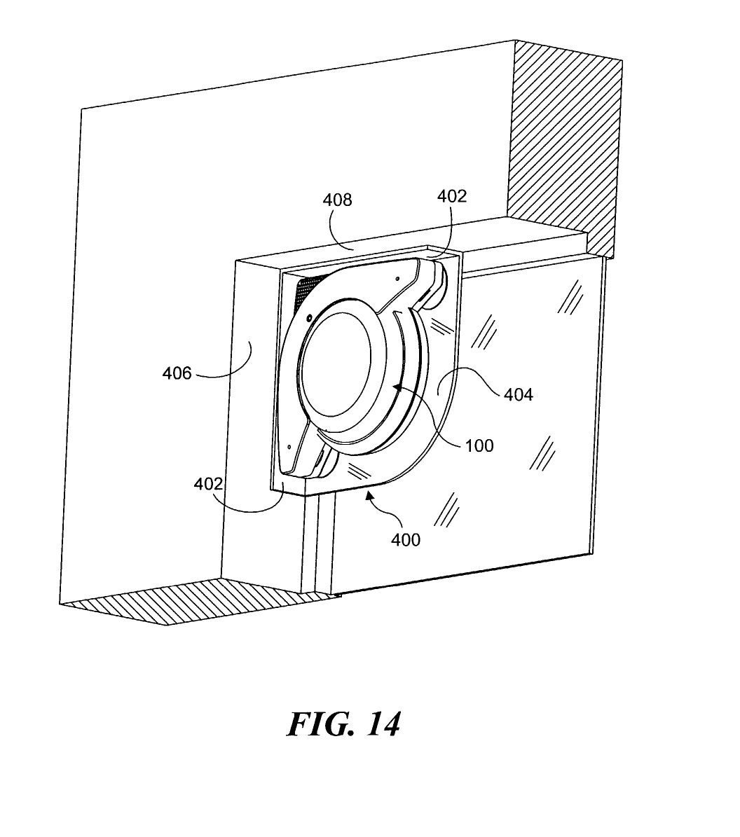

In some instances, it may be desired to mount the FSO transceiver head/mounting apparatus to a window frame, rather than the window itself. For instance, the window might be fragile or have other problems. As illustrate in FIG. 14, this may be accomplished via a window-frame mount adaptor 400. Generally, the window frame-mount adapter will have an open-box configuration, preferably having at least two sides 402 and a base 404. The base of the adapter and the side configuration may be adapted to fit the contours or overall outline of the apparatus mounted to it, as shown in FIG. 14. In one assembly embodiment, appropriate sides 402 of the window-frame mount adapter are secured to corresponding window frame members 406 and 408. Apparatus 100 is then mounted to base 404 in the same manner it would be mounted to a window described above. In another assembly embodiment, apparatus 100 is first mounted to base 404 of the window-frame mount adapter, and then the adapter is secured to the window frame. Preferably, at least the base 404 of the window-frame mount adapter should be made of a material that is optically transparent, comprising one of various plastics or reinforced glasses. The adapter may be formed from a single piece of material, or may comprise an assembled configuration made of one or more materials. Generally, casting and heat/pressure forming operations may be used to manufacture the adapter.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and Figures are accordingly to be regarded as illustrative rather than restrictive. Furthermore, it is not intended that the scope of the invention in any way be limited by the above description, but instead be determined entirely by reference to the claims that follow.

What is claimed is:

1. An apparatus, comprising:
a free-space optical (FSO) transceiver head including optical components configured to facilitate transmission and reception of optical signals; and
a mounting assembly, configured to be mounted to a window and operatively coupled to the FSO transceiver head such that the FSO transceiver head may be positioned relative to the window about at least two axes.

2. The apparatus of claim 1, wherein the FSO transceiver head comprises a binocular configuration including respective transmit and receive optic subassemblies for facilitating transmission and reception of the optical signals.

3. The apparatus of claim 2, wherein the transmit and receive optic subassemblies are substantially identical in configuration.

4. The apparatus of claim 2, wherein the receive optic sub-assembly directs a received optical signal into an end of a receive optical fiber.

5. The apparatus of claim 4, wherein the receive optic sub-assembly includes means for adjusting a position of the end of the receive optical fiber.

6. The apparatus of claim 2, wherein the transmit optic sub-assembly receives a laser signal emitted from an end of a transmit optical fiber and collimates the laser signal to produce the transmitted optical signal.

7. The apparatus of claim 6, wherein the transmit optic sub-assembly includes means for adjusting a position of the end of the transmit optical fiber.

8. The apparatus of claim 1, wherein an envelope of the apparatus has a maximum depth of approximately 3½ inches normal to the window upon installation.

9. The apparatus of claim 1, wherein the mounting assembly includes a base member having a plurality of feet configured to be mounted to the window.

10. The apparatus of claim 9, wherein the plurality of feet are adjustable such that a pointing direction of the FSO transceiver head may be directed toward any angle within a cone of pivotation having a central axis substantially normal to the window.

11. The apparatus of claim 1, wherein the mounting assembly includes:
a base member; and
a coarse pointing ring, rotatably coupled to the base member about a first axis, to which the FSO transceiver head is pivotally mounted about a second axis that is substantially orthogonal to the first axis.

12. The apparatus of claim 11, further comprising a means for locking a pivotal position of the FSO transceiver head relative to the coarse pointing ring.

13. The apparatus of claim 11, wherein the FSO transceiver head is pivotally mounted to the coarse pointing ring via a pair of trunnion mounts.

14. The apparatus of claim 1, further comprising an alignment scope operatively coupled to the FSO transceiver head.

15. The apparatus of claim 14, wherein the alignment scope is coupled to the FSO transceiver head via a magnetic force.

16. The apparatus of claim 14, further comprising means for adjusting a pointing direction of the alignment scope relative to the FSO transceiver head.

17. The apparatus of claim 1, wherein upon being mounted to the window, the FSO transceiver head has a field of regard of at least approximately 90 degrees.

18. The apparatus of claim 1, further comprising a protective cover operatively coupled to either the window or the mounting assembly, to prevent access to the FSO transceiver head.

19. The apparatus of claim 1, wherein the mounting assembly further includes a breakaway means to enable a substantial portion of the mounting assembly and FSO transceiver head to be detached from a window to which the mounting assembly is mounted when a sufficient force is applied to at least one of the mounting assembly and FSO transceiver head, thereby preventing breakage of the window.

20. The apparatus of claim 19, wherein the breakaway means comprise a plurality of detachable feet.

21. The apparatus of claim 1, wherein the window comprises a vehicle window.

22. The apparatus of claim 1, wherein the window comprises a window in one of an outdoor cabinet or out-building.

23. A free-space optical (FSO) transceiver head, comprising:
a chassis, comprising a pair of tubular housings;
a set of receive optics, operatively coupled to one of the tubular housings, including a primary receive optic and a secondary receive optic;
a set of transmit optics, operatively coupled to the other tubular housing, including a primary transmit optic and a secondary transmit optic;
a receive optical fiber, to receive an incoming optical signal from the secondary receive optic; and
a transmit optical fiber, from which an optical beam may be emitted toward the secondary transmit optic.

24. The FSO transceiver head of claim 23, wherein each of the tubular housings are wedge-cut toward a front end of the chassis.

25. The FSO transceiver head of claim 23, further comprising a front plate that is coupled to a front side of the chassis, made of an optically-transparent material.

26. The FSO transceiver head of claim 25, wherein the front plate includes respective backside recesses in which the secondary receive and transmit optics are mounted.

27. The FSO transceiver head of claim 23, wherein the primary receive and transmits optics are coupled to a back-end of respective tubular housings via a plurality of tabs.

28. The FSO transceiver head of claim 23, further comprising a fiber positioner operatively coupled to the receive primary optic, to position an end of the receive optical fiber relative to a focal point of the secondary receive optic.

29. The FSO transceiver head of claim 23, further comprising a fiber positioner operatively coupled to the transmit primary optic, to position an end of the transmit optical fiber relative to a focal point of the secondary transmit optic.

30. The FSO transceiver head of claim 23, further including a beacon coupled to the chassis by which the transceiver may be located.

31. The FSO transceiver head of claim 23, further comprising an alignment scope operatively coupled to the chassis.

32. The FSO transceiver head of claim 31, wherein the alignment scope is coupled to the chassis via a magnetic force.

33. The FSO transceiver head of claim 31, further comprising means for adjusting a pointing direction of the alignment scope relative to the chassis.

34. An apparatus, comprising:
a mounting assembly, configured to be mounted to a structure having a planar surface and having a mounting interface to which an FSO transceiver head may be operatively coupled to the mounting assembly, wherein the mounting assembly and mounting interface are configured such that the FSO transceiver head, upon being operatively coupled thereto, may be positioned relative to the planar surface of the structure about at least two axes.

35. The apparatus of claim 34, wherein the structure comprises a window.

36. The apparatus of claim 35, further comprising a protective cover operatively coupled to at least one of the window and the mounting assembly, to prevent access to the FSO transceiver head.

37. The apparatus of claim 35, wherein the mounting assembly further includes a breakaway means to enable a substantial portion of the mounting assembly and FSO transceiver head to be detached from a window to which the mounting assembly is mounted when a sufficient force is applied to at least one of the mounting assembly and FSO transceiver head, thereby preventing breakage of the window.

38. The apparatus of claim 37, wherein the breakaway means comprise a plurality of detachable feet.

39. The apparatus of claim 35, wherein the mounting assembly includes a base member having a plurality of feet configured to be mounted to the window.

40. The apparatus of claim 39, wherein the plurality of feet are adjustable such that a pointing direction of the FSO transceiver head may be directed toward any angle within a cone of pivotation having a central axis substantially normal to the window.

41. The apparatus of claim 34, wherein the mounting assembly includes:
a base member; and
a coarse pointing ring, rotatably coupled to the base member about a first axis, to which the FSO transceiver head is pivotally mounted about a second axis that is substantially orthogonal to the first axis.

42. The apparatus of claim 41, further comprising a means for locking a pivotal position of the FSO transceiver head relative to the coarse pointing ring.

43. The apparatus of claim 41, wherein the FSO transceiver head is pivotally mounted to the coarse pointing ring via a pair of trunnion mounts.

44. The apparatus of claim 34, further comprising a window-frame mount adapter having a substantially open-box shaped configuration including a base having a planar surface and at least two sides configured to be coupled to a window frame, wherein the mounting assembly is mounted to the base.

45. An apparatus, comprising:
a mounting assembly, configured to be mounted to an structure having a planar surface and including features via which a free-space optical (FSO) transceiver head may be operatively coupled thereto, the mounting assembly including a breakaway means to enable a substantial portion of the mounting assembly and a FSO transceiver head operatively coupled thereto to be detached from a structure to which the mounting assembly is mounted when a sufficient force is applied to at least one of the mounting assembly and FSO transceiver head, thereby preventing damage to the structure.

46. The apparatus of claim 45, wherein the breakaway means comprises a plurality of detachable foot assemblies including a foot member that is fixedly secured to the structure upon assembly and a detachable member that is operatively coupled to the foot member and becomes detached from the foot member in response to the sufficient force applied to at least one of the mounting assembly and FSO transceiver head

47. The apparatus of claim 46, wherein the detachable member is operatively coupled to the foot member via magnetic coupling.

48. The apparatus of claim 46, wherein the detachable member is operatively coupled to the foot member via a ball and socket assembly, wherein the sufficient force applied to at least one of the mounting assembly and FSO transceiver head causes the ball to be decoupled from the socket.

49. The apparatus of claim 45, wherein the structure comprises a window.

50. The apparatus of claim 49, wherein the mounting assembly includes a base member having a plurality of feet configured to be mounted to the window.

51. The apparatus of claim 50, wherein the plurality of feet are adjustable such that a pointing direction of the FSO transceiver head may be directed toward any angle within a cone of pivotation having a central axis substantially normal to the window.

52. The apparatus of claim 45, further comprising a window-frame mount adapter having a substantially open-box shaped configuration including a base having a planar surface and at least two sides configured to be coupled to a window frame, wherein the mounting assembly is mounted to the base.
